(19) United States
(12) Patent Application Publication
(10) Pub. No.: US 2011/0060880 A1
(43) Pub. Date: Mar. 10, 2011

(54) MULTIPROCESSOR

(75) Inventor: Soichiro Hosoda, Kawasaki-shi (JP)

(73) Assignee: KABUSHIKI KAISHA TOSHIBA, Tokyo (JP)

(21) Appl. No.: 12/846,703

(22) Filed: Jul. 29, 2010

(30) Foreign Application Priority Data
Sep. 4, 2009 (JP) 2009-204380

(51) Int. Cl. G06F 12/08; G06F 12/00

(52) U.S. Cl. 711/124; 711/141; 711/130; 711/E12.001; 711/E12.026; 711/E12.038

(57) ABSTRACT

A multiprocessor according to an embodiment of the present invention comprises: a provisional determination unit that provisionally determines one transfer source for each transfer destination by performing predetermined prediction processing based on monitoring of transfer of cache data among cache memories. A data transfer unit activates, after a provisional determination result of the provisional determination unit is obtained, only a tag cache corresponding to the provisionally-determined one transfer source when the transfer of the cache data is performed and determines whether cache data corresponding to a refill request is cached referring to only the activated tag cache.

### CROSS-REFERENCE TO RELATED APPLICATIONS

This application is based upon and claims the benefit of priority from the prior Japanese Patent Application No. 2009-204380, filed on Sep. 4, 2009; the entire contents of which are incorporated herein by reference.

### BACKGROUND OF THE INVENTION

1. Field of the Invention

The present invention relates to a multiprocessor.

2. Description of the Related Art

In the past, when a cache miss occurs in an arbitrary processor in a multiprocessor including a plurality of processors including cache memories, a coherency managing unit that manages cache coherency in the multiprocessor activates all tag memories provided to correspond to the cache memories of the processors and checks presence or absence of a cache line as a refill target.

As a result of checking presence or absence of a cache line as a refill target, when cache lines as refill targets are present in a plurality of cache memories, the coherency managing unit performs transfer of the cache lines without taking into account power consumption in the multiprocessor (the cache memories, a common bus, an arbitration circuit, etc.) when a cache line is transferred to the cache memory in which cache miss occurs.

However, in the related art, the check of presence or absence of a cache line as a refill target and the transfer of a cache line are inefficient from the viewpoint of power consumption.

Japanese Patent Application Laid-Open No. 2002-49600 discloses a technique for storing, when write operation in a data block that maintains coherency is performed in a common memory multiprocessor, a processor disabled because of data sharing in a shift register and transferring a write result to a processor at a prediction destination to improve performance. However, a prediction is speculatively performed at timing when write occurs in a certain data block and a write result is transferred before the write result is actually required. Therefore, accuracy of the prediction is low and the prediction does not always lead to improvement of performance.

### BRIEF SUMMARY OF THE INVENTION

A multiprocessor according to an embodiment of the present invention comprises: a main storage device;

a plurality of processors that respectively include cache memories for temporarily storing stored data of the main storage device and share the main storage device; and

a coherency managing unit that manages coherency of the cache memories of the processors, wherein

the coherency managing unit includes:
a plurality of tag caches that are provided to correspond to the respective cache memories and store tags of cache data cached in the cache memories corresponding to the tag caches;
a data transfer unit that discriminates, according to a refill request from the processors, a cache memory in which cache data corresponding to the refill request is cached referring to the tag caches and performs transfer of the cache data corresponding to the refill request, in which the discriminated cache memory is a transfer source and the cache memory at a refill request source is a transfer destination; and
a provisional determination unit that provisionally determines one transfer source for each transfer destination by performing predetermined prediction processing based on monitoring of transfer of cache data among the cache memories, and

the data transfer unit activates, after a provisional determination result of the provisional determination unit is obtained, only a tag cache corresponding to the provisionally-determined one transfer source when the transfer of the cache data is performed and determines whether the cache data corresponding to the refill request is cached referring to only the activated tag cache.

### BRIEF DESCRIPTION OF THE DRAWINGS

FIG. 1 is a diagram of the configuration of a multiprocessor according to a first embodiment of the present invention;

FIG. 2 is a diagram of a flow of operation performed when the multiprocessor according to the first embodiment executes a computer program in four processor units in parallel;

FIG. 3 is diagram of a state in which the processor unit accesses processing target data and causes a cache miss;

FIG. 4 is a diagram of a state in which a cache memory line is intervention-transferred to a processor unit that is a refill request source;

FIG. 5 is a diagram of operation during intervention transfer performed after a PIU is switched to a predicting intervention mode;

FIG. 6 is a diagram of a system for releasing the predicting intervention mode by a two-stage threshold system;

FIG. 7 is a diagram of a system for releasing the predicting intervention mode using an interval counter;

FIG. 8 is a diagram of an example of the configuration of a multiprocessor in which predicting intervention units are distributedly arranged in processor units;

FIG. 9 is a diagram of the configuration of multiprocessor according to a second embodiment of the present invention;

FIG. 10 is a diagram of a flow of operation performed when the multiprocessor according to the second embodiment executes a computer program in two processor units in parallel;

FIG. 11 is a diagram of a state in which a cache memory line is intervention-transferred to a processor unit that is a refill request source;

FIG. 12 is a diagram of a state in which a processor unit accesses processing target data and causes a cache miss;

FIG. 13 is a diagram of a state in which a cache memory line is intervention-transferred to a processor unit that is a refill request source;

FIG. 14 is a diagram of operation during intervention transfer performed after a PIU is switched to a predicting intervention mode;

FIG. 15 is a diagram of the configuration of a multiprocessor according to a third embodiment of the present invention;

FIG. 16 is a diagram of a state in which intervention transfer is performed and a counter of a corresponding processor pair of a PI counter is incremented;

FIG. 17 is a diagram of a state in which intervention transfer is performed and a counter of a corresponding processor pair of the PI counter is incremented;

FIG. 18 a diagram of a state in which a hit is obtained by referring only one L1 tag cache in a validated state of a predicting intervention mode;

FIG. 19 is a diagram of an example of the configuration of a multiprocessor in which processor units, a CMU, and a main memory are connected by a ring bus;

FIG. 20 is a diagram of a state of intervention transfer in a multiprocessor of a ring bus form;

FIG. 21 is a diagram of a state of intervention transfer in the multiprocessor of the ring bus form;

FIG. 22 is a diagram of the, configuration of a multiprocessor according to a fourth embodiment of the present invention;

FIG. 23 is a diagram of a state in which processor units write a lock variable in the same memory area according to “sc”; and

FIG. 24 is a diagram of a state in which a cache miss occurs in an L1 cache memory after a predicting intervention mode is turned on.

### DETAILED DESCRIPTION OF THE INVENTION

Exemplary embodiments of multiprocessor according to the present invention will be explained below in detail with reference to the accompanying drawings. The present invention is not limited to the following embodiments.

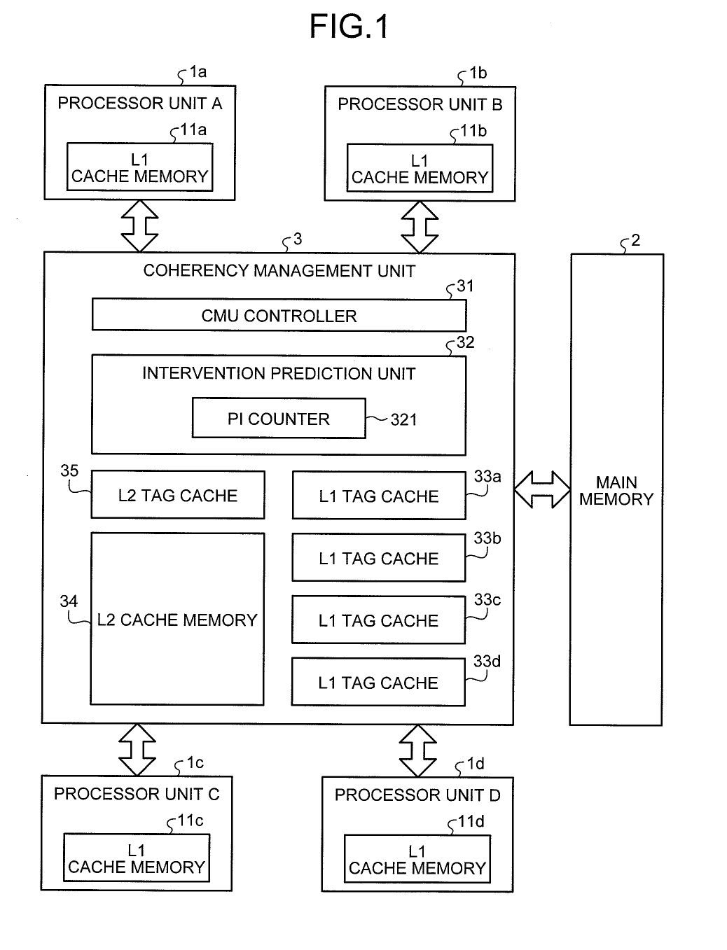

FIG. 1 is a diagram of the configuration of a multiprocessor according to a first embodiment of the present invention.

The multiprocessor includes processor units 1 (1a to 1d), a main memory 2, and a coherency management unit (CMU) 3. In the following explanation, the processor units 1a, 1b, 1c, and 1d are respectively abbreviated as PU-A, PU-B, PU-C, and PU-D when necessary.

The processor units 1a to 1d manage arithmetic processing and command execution. The processor units 1a to 1d include L1 cache memories (primary cache memories) 11a to 11d. The L1 cache memories 11a to 11d have stored therein cache lines including data fields and tag fields. The processor units 1a to 1d determine a cache hit or a cache miss based on tags included in the cache lines when the L1 cache memories 11a to 11d included therein are accessed. In the case of a cache hit, the processor units 1a to 1d access data in the hit cache line. In the case of a cache miss, the processor units 1a to 1d output a refill request to the CMU 3. When the processor units 1a to 1d use virtual addresses, the tags in the L1 cache memories 11a to 11d are represented by the virtual addresses.

The CMU 3 manages cache coherency in the multiprocessor. The CMU 3 includes a CMU controller 31, a predicting intervention unit (PIU) 32, L1 tag caches 33 (33a to 33d), an L2 cache memory (a secondary cache memory) 34, and an L2 tag cache 35.

The L1 tag caches 33a to 33d are provided to respectively correspond to the L1 cache memories 11a to 11d and store tags (addresses) in the L1 cache memories 11a to 11d. The L2 cache memory 34 stores data and the L2 tag cache 35 stores a tag (an address) in the L2 cache memory 34. Even when the processor units 1a to 1d use virtual addresses, the tags in the L1 tag caches 33a to 33d are represented by actual addresses. Therefore, the CMU 3 includes a memory management unit (MMU) and performs conversion of a virtual address and an actual address in the MMU.

The CMU controller 31 assumes a role of a control system of the CMU 3. Specifically, the CMU controller 31 refers to the tag caches (the L1 tag caches 33a to 33d and the L2 tag cache 35) in response to refill requests from the processor units 1a to 1d and obtains a cache hit or a cache miss. When a cache hit occurs, the CMU controller 31 sets the hit cache memory as a transfer source and performs transfer of a cache line to a processor unit at a refill request source. On the other hand, when a cache miss occurs, the CMU controller 31 sets the main memory 2 as a transfer source and performs transfer of a cache line to a processor unit at a refill request source. Further, the CMU controller 31 performs, for example, processing for updating the L1 tag caches 33a to 33d to latest tag information when write operation by the processor units 1a to 1d is performed or when cache line transfer is performed and snoop control (e.g., processing for, when an arbitrary cache memory updates an address shared by a plurality of cache memories, regarding that the address is dirty and validate a line corresponding to the address of another cache memory that shares the address). The PIU 32 predicts a tendency of transfer of a cache line (hereinafter intervention transfer) among the L1 cache memories 11a to 11d involved in the snoop control.

Like the L2 cache memory 34, the L1 cache memories 11a to 11d can be configured to store only data. However, in this case, when the CMU controller 31 accesses the L1 cache memories 11a to 11d included in the processor units 1a to 1d, load on the CMU 3 increases because the CMU controller 31 also needs to determine a cache hit or a cache miss. Therefore, it is desirable to store tags in the L1 cache memories 11a to 11d together with the data and output a refill request to the CMU 3 only when a cache miss occurs in the processor units 1a to 1d.

The PIU 32 includes a counter of predicting intervention counter (PI counter) 321. A counter corresponding to intervention transfer among processor units and a storage device that stores a threshold when a prediction mode is turned on are present in the PI counter 321. The PI counter 321 can perform counting for each set of kinds of inter-processor transfer. In the system including the four processor units 1a to 1d, what could be intervention transfer sources for all the processor units 1a to 1d are five cache memories: the L1 cache memories 11a to 11d and the L2 cache memories 34. Therefore, the PI counter 32 separately counts twenty (5×4) kinds of transfer. Specifically, the PI counter 32 separately counts twenty kinds of intervention transfer: PU-A←PU-A, PU-A←PU-B, PU-A←PU-C, PU-A←PU-D, PU-A←L2, PU-B←PU-A, PU-B←PU-B, PU-B←PU-C, PU-B←PU-D, PU-B←L2, PU-C←PU-A, PU-C←PU-B, PU-C←PU-C, PU-C←PU-D, PU-C←L2, PU-D←PU-A, PU-D←PU-B, PU-D←PU-C, PU-D←PU-D, AND PU-D←L2.

In view of generality of the configuration of the multiprocessor, the L2 cache memory 34 and the L2 tag cache 35 are arranged in the CMU 3. However, the L2 cache memory 34 and the L2 tag cache 35 do not have to be present and can be omitted as required.

A method of connecting the CMU 3 to the processors 1 and the main memory 2 may be a system different from that shown in FIG. 1, for example, bus connection.

In FIG. 1, the four processors (1a to 1d) are arranged in the multiprocessor. However, the number of processors is arbitrary as long as the number is equal to or larger than two. This is because transfer of a cache line is not limited to transfer between different L1 cache memories and is likely to be performed in the same L1 cache memory. In other words, this is because, even in a multiprocessor including two processors, to check presence or absence of a cache line as a refill target, it is necessary to activate tag memories of a plurality of cache memories in the multiprocessor.

More specifically, when the processors use virtual addresses, in a refill request transmitted from a processor unit when a cache miss occurs in an L1 cache memory, a cache line is designated by a virtual address. As a result of converting the virtual address into an actual address in a MMU, in some cases, it is found that a desired memory line is present in an L1 cache memory of a processor at a transmission source of the refill request. In this case, transfer of a cache line is performed in the L1 cache memory of the same processor unit.

Therefore, even when there are two processors and a secondary cache is omitted, a transfer source of intervention transfer is not unconditionally decided. To check presence or absence of a cache line as a refill target, it is necessary to activate tag memories of all the cache memories in the multiprocessor.

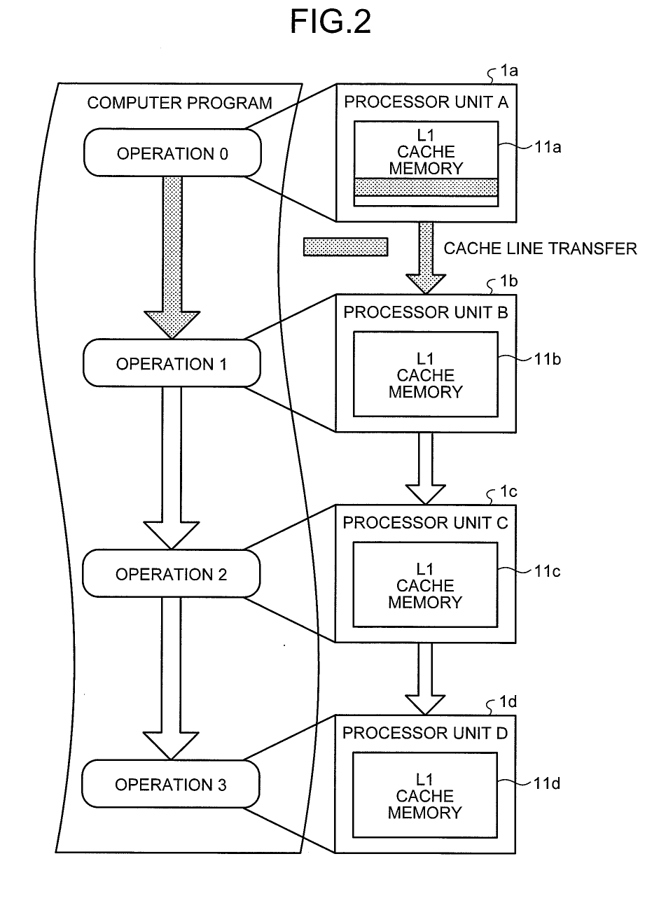

A prediction system of the PIU 32 is explained below. FIG. 2 is a diagram of a flow of operation performed when the multiprocessor according to this embodiment executes a computer program in the four processor units 1a to 1d in parallel. It is assumed that processing of operations 0 to 3 is present in the computer program and the processor units 1a to 1d respectively perform the processing of the operations 0 to 3. In this case, the processor units 1 capture processing target data and a command code for performing the processing into the L1 cache memories 11a to 11d present in the processor units 1 from the main memory 2 to realize an increase in speed of the processing.

As it is evident from the processing flow shown in FIG. 2, cache data processed by the processor units 1a to 1c is transferred to the next processor units 1b to 1d that perform the following processing and subjected to the following processing by the processor units 1b to 1d. Actually, the cache data is transferred according to a cache miss in the next processor units 1b to 1d and refill operation involving intervention transfer.

In operation explained below, a cache line including data subjected to the processing of the operation 0 by the processor unit 1a is transferred to the processor unit 1b that performs the following processing of the operation 1 and the processing is continued.

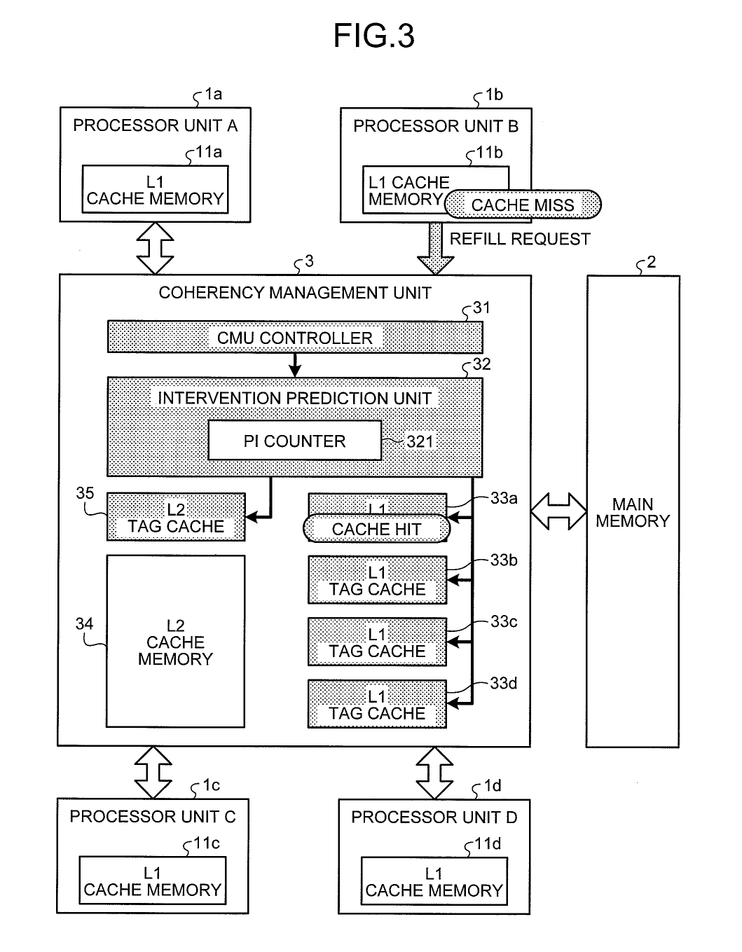

FIG. 3 is a diagram of a state in which the processor unit 1b accesses processing target data (actually, accesses the L1 cache memory 11b in the processor unit 1b) and causes a cache miss. To perform refill of the L1 cache memory 11b, the processor unit 1b notifies a CMU 3 of a refill request. The CMU controller 31 accesses a tag cache memory present in the CMU 3 and determines whether a requested cache line is present in the multiprocessor. At this point, because transfer by the PIU 32 is not predicted, the CMU controller 31 needs to access all the tag cache memories (the L1 tag caches 33a to 33d and the L2 tag cache 35). A section indicated by hatching in the figure is a section in which hardware (a logic memory, etc.; hereinafter abbreviated as HW (hardware)) is driven and consumes electric power). As a result of access to all the tag caches and address comparison, it is found that the requested cache line is present in the L1 cache memory 11a in the processor unit 1a. It is also evident from a program execution flow that it is highly likely that the requested cache line is present in the L1 cache memory 11a in the processor unit 1a that performs processing at a pre-stage of the processor unit 1b.

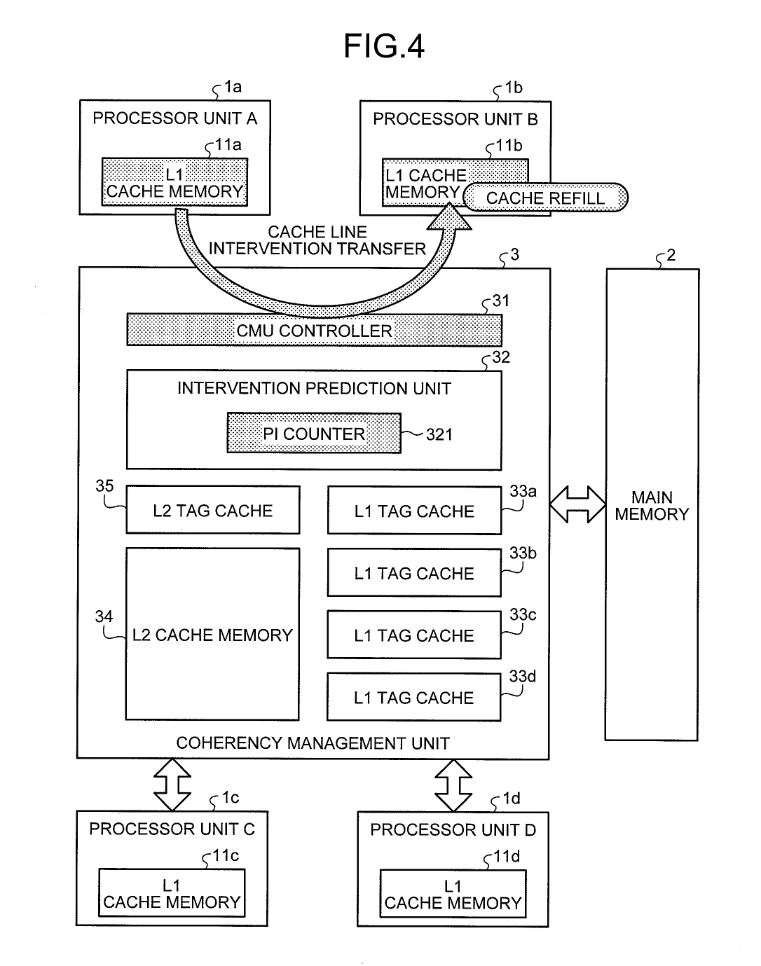

Subsequently, as shown in FIG. 4, the CMU controller 31 intervention-transfers a cache memory line in the L1 cache memory 11a to the processor unit 1b that is a refill request source. When the cache memory line is intervention-transferred, the CMU controller 31 increments a value of the PI counter 321. In FIG. 4, the intervention transfer of the cache line from the processor unit 1a to the processor unit 1b occurs. Therefore, a “counter for PUb←PUa prediction” corresponding to intervention transfer from PU-A to PU-B among twenty counters is incremented.

The PIU 32 switches to, based on the value of the PI counter 321, an “predicting intervention mode” for limiting a cache memory as an access destination to lower an HW driving ratio during intervention transfer between a specific processor (L1 cache memory) pair and reduce power consumption of the multiprocessor. In the following explanation, a state after the switching to the “predicting intervention mode” is referred to as “the predicting intervention mode is valid”.

For the PIU 32 to switch to the predicting intervention mode, a counter value of the PI counter 321 needs to exceed a predicting intervention mode on threshold (hereinafter, “prediction mode on threshold”). As in the processing flow shown in FIG. 2, when the cache data is transferred from the processor unit 1a to the processor unit 1b together with the processing and the processing is performed, the intervention transfer from the processor unit 1a to the processor unit 1b frequently occurs. Therefore, it is expected that the counter value exceeds the prediction mode on threshold.

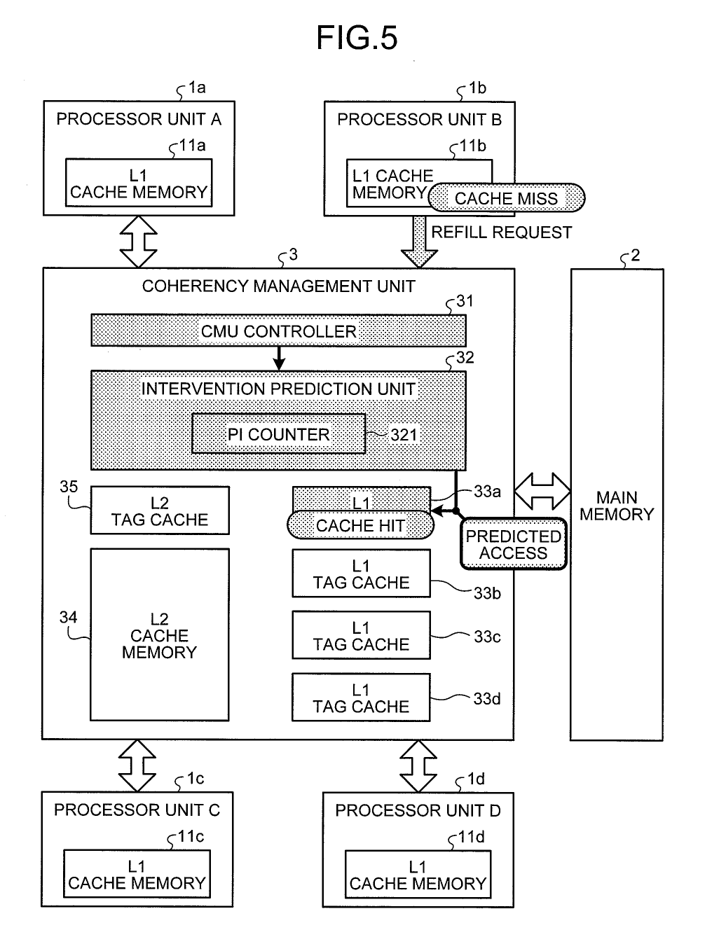

FIG. 5 is a diagram of operation after a value of the counter for PUb←PUa prediction of the PI counter 321 exceeds the prediction mode on threshold because of intervention transfer performed in the past and the PIU 32 switches to the predicting intervention mode (in other words, operation performed when the predicting intervention mode is valid). In FIG. 5, a cache miss occurs in the L1 cache memory 11b of the processor unit 1b and a refill request is sent to the CMU 3. At this point, the PIU 32 is in the predicting intervention mode and predicts that a cache line requested by the L1 cache memory 11b is present in the L1 cache memory 11a. It is necessary to read out all the tag caches in a state without a prediction. However, a reduction in power consumption is attained by reading out only the L1 tag cache 33a related to the L1 cache memory 11a according to the prediction of the PIU 32.

In a processing flow shown in FIG. 2, a prediction is correct at a high probability and a hit is obtained from the L1 tag cache 33a. After the hit is confirmed by the CMU controller 31, intervention transfer of the cache line is performed from the L1 cache memory 11a and the L1 cache memory 11b.

A system for releasing the validated predicting intervention mode is explained below.

Examples of the system for releasing the predicting intervention mode include a system for releasing the predicting intervention mode using two-stage thresholds, a system for releasing the predicting intervention mode using an interval counter, and a system for releasing the predicting intervention mode because of a prediction failure.

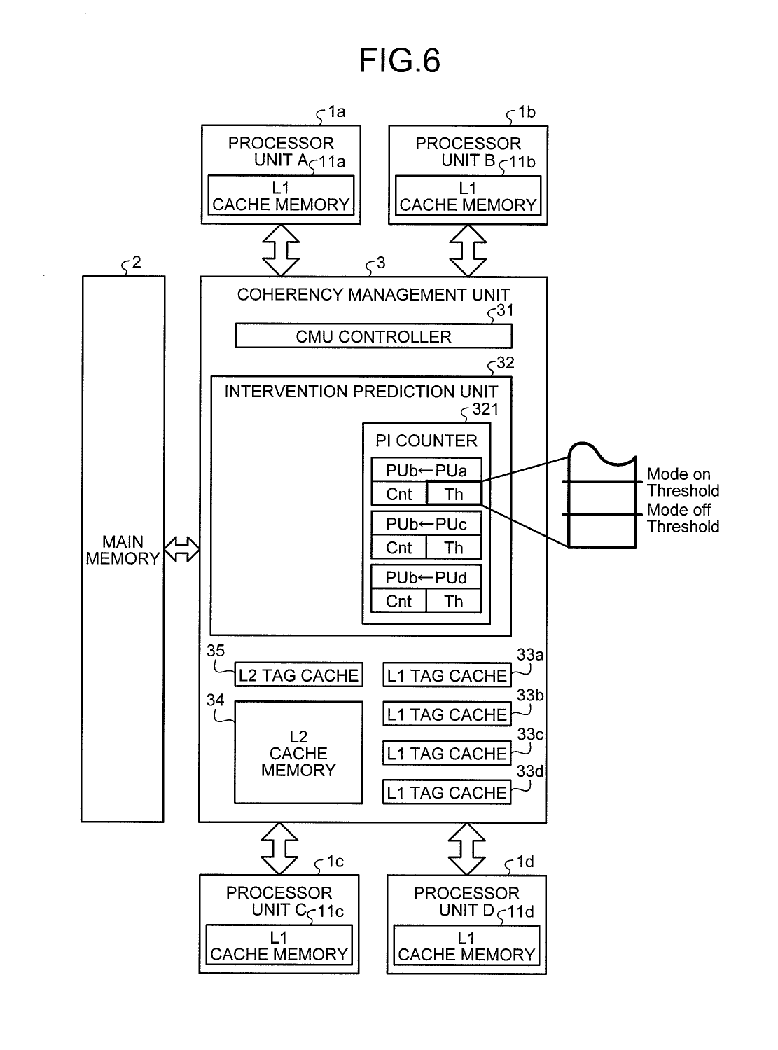

In the system for releasing the predicting intervention mode using two-stage thresholds, as shown in FIG. 6, the PI counter 321 is configured to be capable of setting thresholds in two stages. When the PI counter 321 in the PIU 32 exceeds a prediction mode on threshold “Mode_on_Th” (or reaches the threshold), the predicting intervention mode of the PIU 32 changes to valid. Conversely, when the PI counter 321 falls below a predicting intervention mode off threshold (hereinafter, “prediction mode off threshold”) “Mode_off_Th” (or reaches the threshold), the predicting intervention mode changes to invalid. The PI counter 321 is incremented when intervention transfer is performed from a processor unit as a measurement target to a processor unit forming a specific pair with the processor unit. The PI counter 321 is decremented when intervention transfer is performed from the processor unit as the measurement target to a different processor unit. For example, when a refill request due to a cache miss is sent from the processor unit 1b to the CMU 3, the counter for PUb←PUa is incremented if an intervention transfer source is the processor unit 1a. The counter for PUb←PUa is decremented if the intervention transfer source is other than the processor unit 1a. A value of the prediction mode off threshold “Mode_off_Th” is arbitrary as long as the value is the same as or smaller than the prediction mode on threshold “Mode_on_Th”.

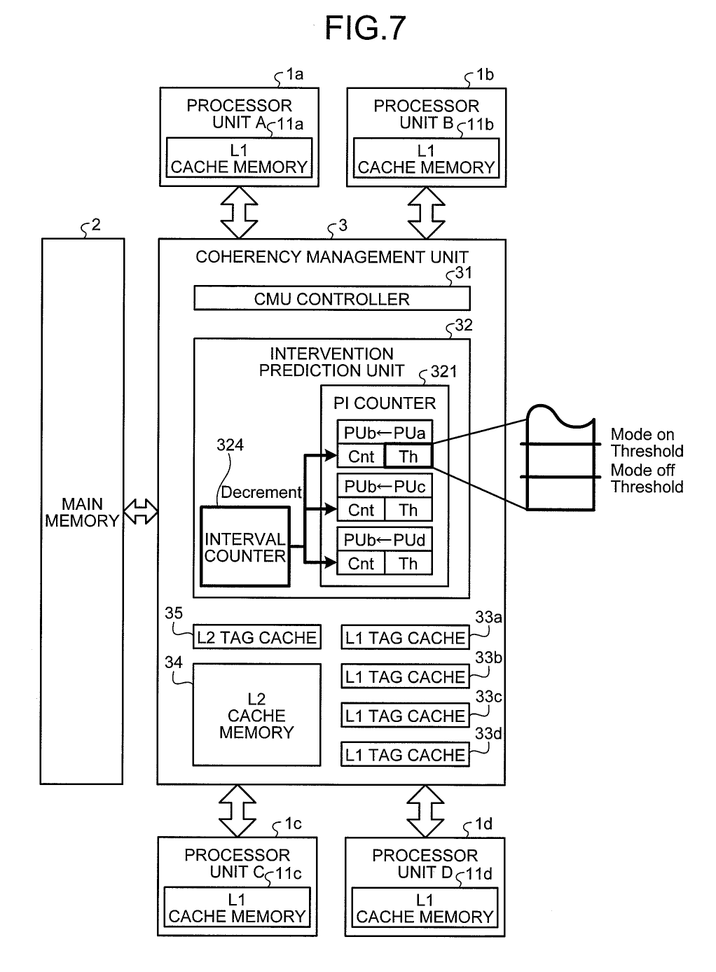

When the system for releasing the predicting intervention mode using an interval counter is adopted, as shown in FIG. 7, the PI counter 321 is configured to be capable of setting thresholds in two stages. An interval counter 324 is provided in the PIU 32. The interval counter 324 decrements a counter value of the PI counter 321 as a fixed time elapses.

As in the system for releasing the predicting intervention mode using two-stage thresholds, when intervention transfer occurs between a specific pair of processor units, the PI counter 321 is incremented. However, temporal locality is taken into account by decrementing the counter value of the PI counter 321 using the interval counter 324 according to the elapse of time. Specifically, it is likely that accuracy of a prediction based on intervention transfer executed a long time before is low. Therefore, the PI counter 321 is biased in a direction of invalidation by the interval counter 324 according to the elapse of time to secure accuracy of a prediction.

The system for releasing the predicting intervention mode because of a prediction failure is a conservative system for invalidating the intervention prevention mode (and clearing the PI counter 321 to 0) when a prediction fails at least once after the predicting intervention mode is validated.

When a prediction of intervention transfer fails, presence of a cache line as a transfer target has to be checked again after activating the tag memories of all the cache memories. Therefore, power consumption and processing time increase. However, in this system, because the predicting intervention mode is invalidated if a prediction fails at least once, predictions are not repeatedly wrong. This makes it possible to prevent the increase in power consumption and processing time.

When the number of times of intervention transfer is separately measured among a plurality of processor pairs and ON and OFF of the predicting intervention mode are switched as explained above, it is likely that, concerning the processor pairs having different transfer sources, a counter value of the intervention transfer prediction counter exceeds the prediction mode on threshold. For example, it is likely that both the counter for PUb←PUa and the counter for PUb←PUc exceed the prediction mode on threshold. Five specific examples of a selection system for the CMU 3 to select an intervention mode concerning which processor pair should be adopted in such a state are explained below. However, the selection system is not limited to systems explained below.

When the intervention prevention mode is turned on concerning a certain processor pair, the PIU 32 stops the PI counter 321 concerning the other processor pairs.

When the intervention prevention mode is turned on concerning a certain processor pair, the PIU 32 sets, concerning processor pairs for which counter values of the PI counter 321 exceed the prediction mode on threshold (or reach the threshold), high priorities in order of earliness of time when the counter values exceed the prediction mode threshold (reaches the threshold). When the predicting intervention mode that is currently ON is released, the PIU 32 turns on the predicting intervention mode of a processor pair having the highest priority.

Priorities of the processor pairs are set in advance. The PIU 32 turns on the predicting intervention mode of a processor pair having the highest priority among processor pairs for which counter values of the PI counter 321 exceeds the prediction mode on threshold (or reaches the threshold). (Example: “PUb←PUa”>“PUb←PUc”>“PUb←PUd”)

Higher priorities are set for the processor pairs as excesses of counter values of the PI counter 321 from the prediction mode on threshold are larger. The PIU 32 turns on the predicting intervention mode of a processor pair having the highest priority.

The PIU 32 turns on the predicting intervention mode of a processor pair, a prediction for which is correct in nearest past.

As explained above, the multiprocessor according to this embodiment predicts a tendency of intervention transfer among the processors, starts only a tag memory concerning a cache memory in which a cache line as a transfer target is predicted to be present, and checks presence or absence of the cache line. Therefore, it is possible to lower an HW driving ratio during intervention transfer between a specific processor (L1 cache memory) pair and reduce power consumption of the multiprocessor.

Moreover, a prediction is made at timing when a cache miss is actually occurs and the multiprocessor requests a cache line. Therefore, accuracy of the prediction is high and an increase in power consumption and an increase in processing time due to a wrong prediction are less easily caused.

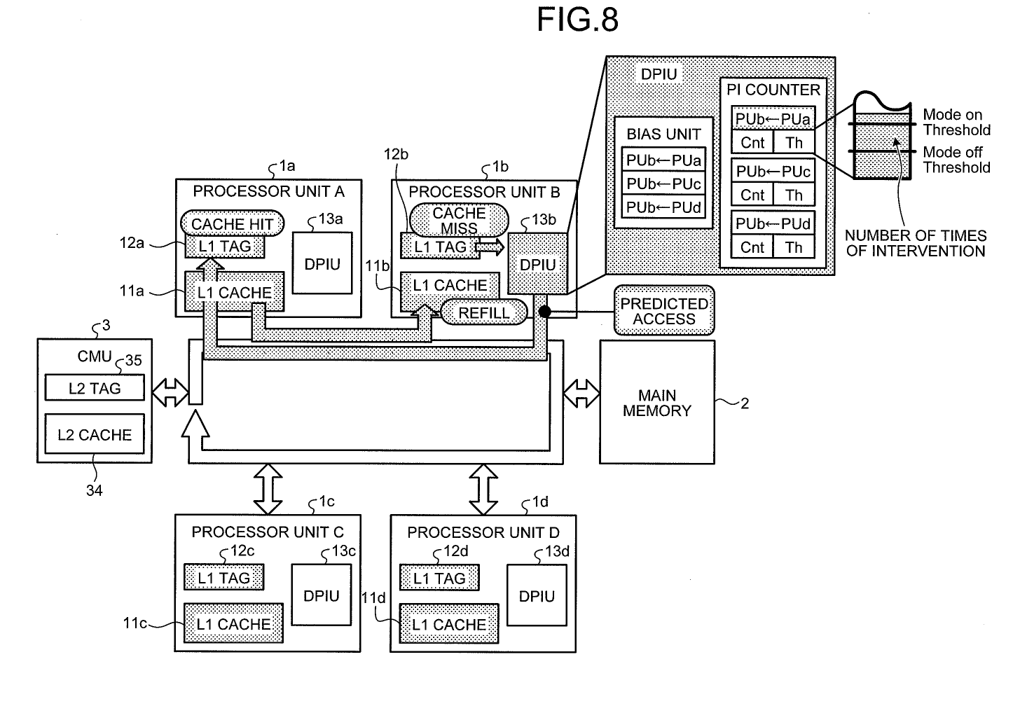

In the example explained above, the PIU 32 is aggregated in the CMU 3. However, it is possible to realize the same prediction algorithm by, as shown in FIG. 8, distributedly arranging predicting intervention units in the processor units 1 as distributed predicting intervention units (DPIUs) 13a to 13d and arranging, in the DPIUs 13a to 13d, counters related to the processor units 1a to 1d (e.g., in the processor unit 1b, five counters related to intervention transfer for PU-B←PU-A, PU-B←PU-B, PU-B←PU-C, PU-B←PU-D, and PU-B←L2).

In FIG. 8, a cache miss occurs in the L1 cache memory 11b of the processor unit 1b and the counter for “PUb←PUa” exceeds the prediction mode on threshold according to a prediction of the DPIU 13b. Intervention transfer from the processor unit 1a is predicted and the L1 tag cache 12a in the processor unit 1a is referred to obtain a cache hit. A cache line is refilled in the L1 cache memory 11b from the L1 cache memory 11a.

Even when the intervention prevention units are distributedly arranged in the processor units in this way, an effect same as the effect obtained by aggregating and arranging the predicting intervention units in the CMU 3 can be obtained. The same holds true concerning other embodiments.

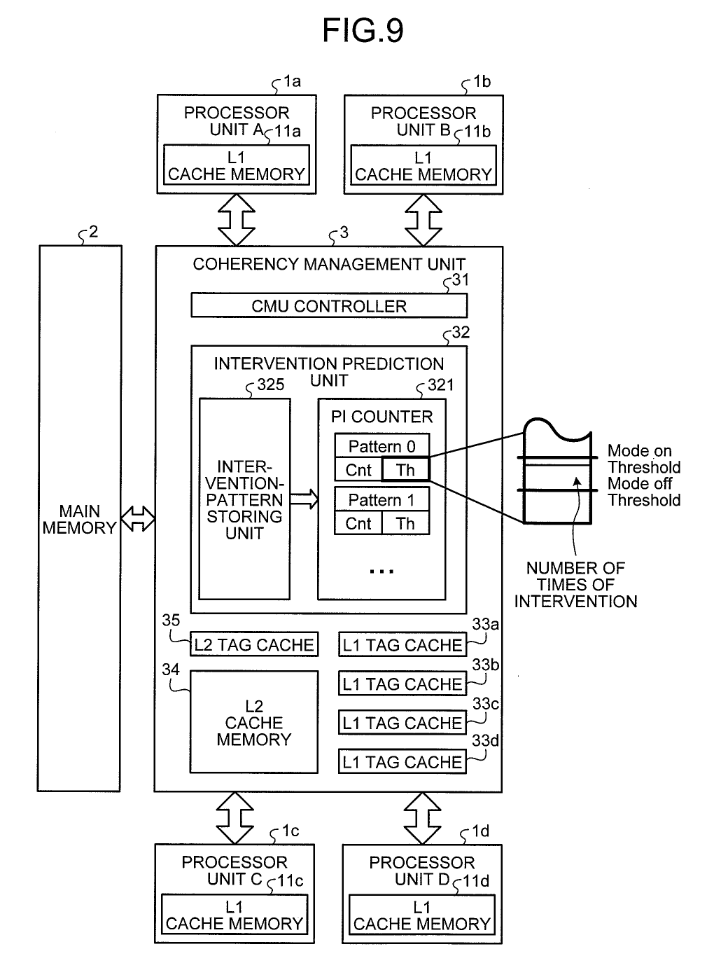

FIG. 9 is a diagram of the configuration of a multiprocessor according to a second embodiment of the present invention. The multiprocessor has a configuration substantially the same as that of the multiprocessor according to the first embodiment but is different in that the multiprocessor further includes an intervention-pattern storing unit 325.

The counters in the PI counter 321 are pattern counters corresponding to intervention transfer patterns (patterns formed by two or more times of intervention transfer) rather than the processor pairs.

Specific intervention transfer patterns are stored in the intervention-pattern storing unit 325. As examples, there are a pattern in which intervention transfer is performed such that a cache memory line is transferred through specific processor units and a pattern in which intervention transfer is performed such that a cache memory line is transferred back and forth between specific processor units.

Specific examples of the former pattern include:

PU-A→PU-B→PU-A

PU-A→PU-B→PU-C→PU-A

PU-A→PU-B→PU-D→PU-A

PU-A→PU-B→PU-C→PU-D→PU-A

PU-A→PU-B→PU-D→PU-C→PU-A

On the other hand, specific examples of the latter pattern include:

PU-A→PU-B→PU-A

PU-A→PU-B→PU-C→PU-B→PU-A

PU-A→PU-B→PU-D→PU-B→PU-A

PU-A→PU-B→PU-C→PU-D→PU-C→PU-B→PU-A

PU-A→PU-B→PU-D→PU-C→PU-D→PU-B→PU-A

The intervention transfer patterns are stored in the intervention-pattern storing unit 325. When intervention transfer coinciding with the stored pattern occurs, pattern counters corresponding to entries of the PI counter 321 are incremented. The intervention transfer patterns can be associated with the pattern counters in a one to one relation. A plurality of patterns can be allocated to one counter (e.g., similar patterns such as PU-A→PU-B→PU-C→PU-A and PU-A→PU-B →PU-D→PU-A are allocated to one counter) and counted.

The PIU 32 turns on the predicting intervention mode when a pattern counter of the PI counter 321 exceeds the prediction mode on threshold (or reaches the threshold). The PIU 32 turns off the predicting intervention mode when the pattern counter of the PI counter 321 falls below the prediction mode off threshold (of reaches the threshold). Concerning release of the predicting intervention mode, as in the first embodiment, it is also possible to adopt a system for releasing the predicting intervention mode using an interval counter and a system for immediate release due to a prediction failure.

As a system for performing matching with the intervention transfer pattern, it is possible to adopt both a system for performing matching with a pattern simply following the order of intervention transfer without comparing addresses and a system for performing matching with a pattern following the order of intervention transfer for the same address. When the order of the intervention transfer for the same address is followed, a pattern is regarded as occurring only when the intervention transfer of the pattern order occurs for the same address.

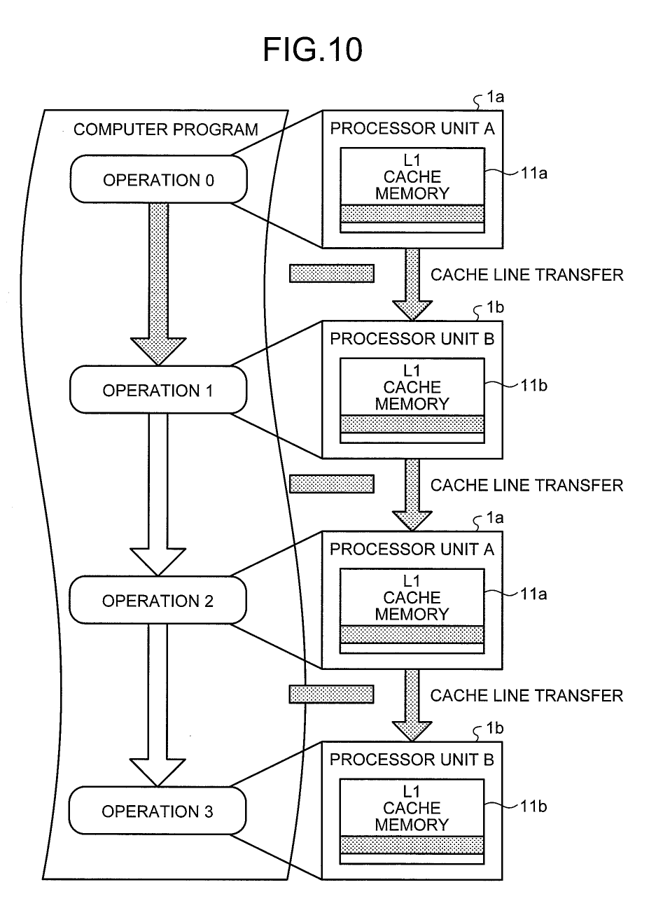

FIG. 10 is a diagram of a flow of operation performed when the two processor units 1a and 1b execute a computer program in parallel. The operation is an example of the operation of the multiprocessor according to this embodiment. It is assumed that processing of operations 0 to 3 is present in the computer program, the processing of the operations 0 and 2 is performed by the processor unit 1a and the processing of the operations 1 and 3 is performed by the processor unit 1b. In this case, the processor units 1a and 1b capture processing target data and a command code for performing the processing into the L1 cache memories 11a and 11b present therein from the main memory 2 to realize an increase in speed of the processing.

In operation explained below, a cache line including data subjected to the processing of the operation 0 by the processor unit 1a is transferred to the processor unit 1b that performs the following processing of the operation 1. A cache line subjected to the processing of the operation 1 is transferred to the processor unit 1a again and the processing of the operation 2 and subsequent operations is continued. It is assumed that a pattern of the L1 cache memory 11a→the L1 cache memory 11b→the L1 cache memory 11a is stored in the intervention-pattern storing unit 325.

When the processor unit 1b is about to read the cache line subjected to the processing of the operation 0 by the processor unit 1a, because the cache line is present in the L1 cache memory 11a, a cache miss occurs in the L1 cache memory 11b. Therefore, the processor unit 1b issues a refill request to the CMU 3. The CMU controller 31 accesses all the tag caches (the L1 tag caches 33a to 33d and the L2 tag cache 35) provided in the CMU 3 to recognize that a desired cache line is present in the L1 cache memory 11a (same as the processing shown in FIG. 3).

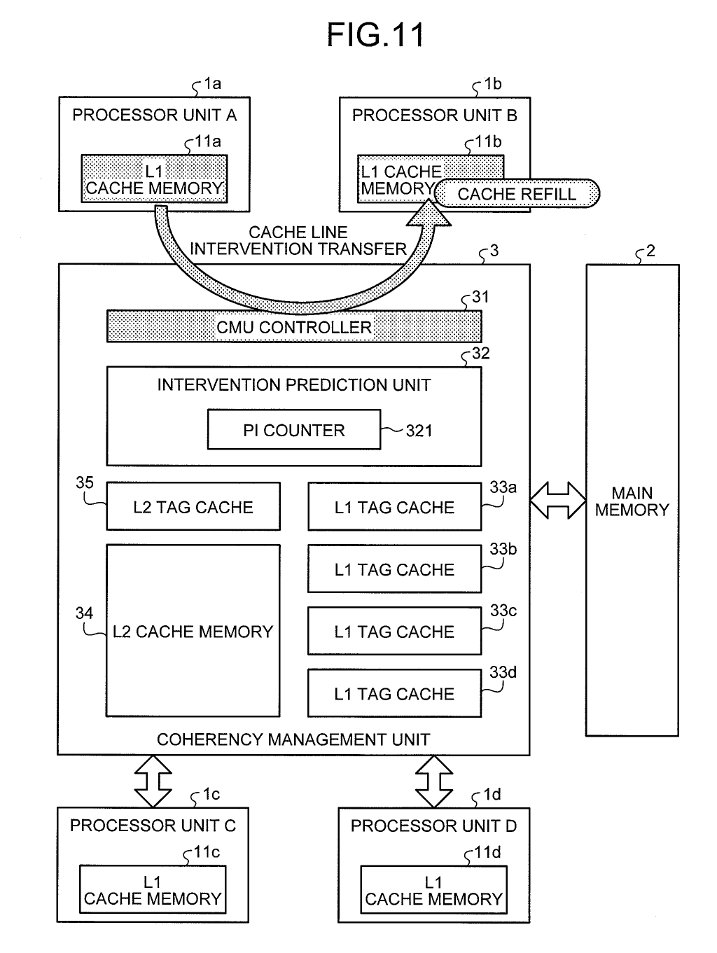

Thereafter, as shown in FIG. 11, the cache line is intervention-transferred from the L1 cache memory 11a to the L1 cache memory 11b. In the first embodiment, the counter for PUb←PUa prediction of the PI counter 321 is incremented at a stage when the intervention transfer from the L1 cache memory 11a to the L1 cache memory 11b is performed. However, in this embodiment, the pattern counter of the PI counter 321 is not incremented at this stage.

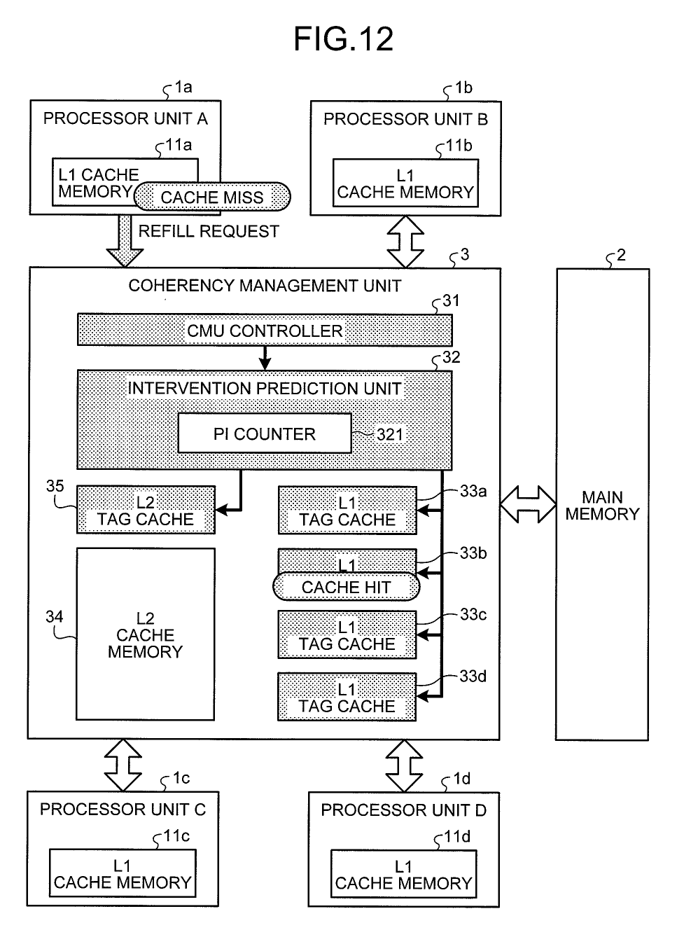

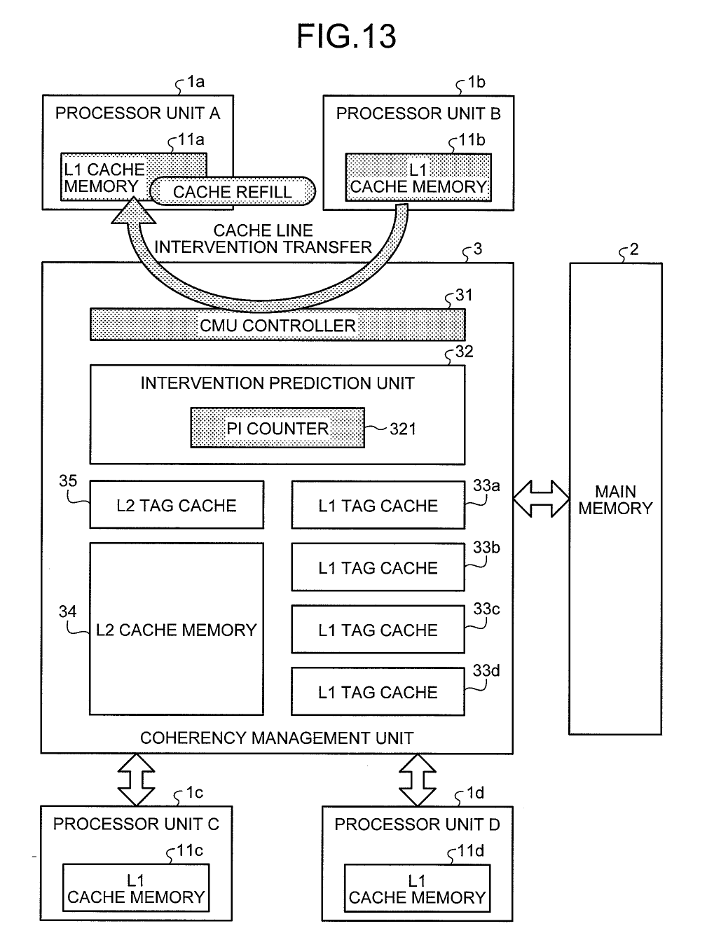

Thereafter, the cache line subjected to the processing of the operation 1 by the processor unit 1b (the L1 cache memory 11b) is accessed from the processor unit 1a (the L1 cache memory 11a) to perform the processing of the operation 2. At this point, because the cache line is present in the L1 cache memory 11b, as shown in FIG. 12, a cache miss occurs in the L1 cache memory 11a. A refill request from the processor unit 1a reaches the CMU 3. At this point, because a prediction mode of the PIU 32 is an off state, the CMU 3 reads all the tag caches (the L1 tag caches 33a to 33d and the L2 tag cache 35) and obtains a hit in the L1 tag cache 33b in which a requested cache line is present. Thereafter, as shown in FIG. 13, the cache line is intervention-transferred from the L1 cache memory 11b to the L1 cache memory 11a at the request source.

At a point when the cache line is transferred from the L1 cache memory 11a to the L1 cache memory 11b and then transferred to the L1 cache memory 11a, the cache line coincides with the pattern stored in the intervention-pattern storing unit 325. Therefore, the pattern counter of “PU-A→PU-B→PU-A” of the PI counter 321 is incremented.

When the processor unit 1a and the processor unit 1b alternately perform program processing as indicated by the program processing flow shown in FIG. 10, the intervention transfer between the processor unit 1a and the processor unit 1b frequently occurs. Therefore, it is expected that a counter value of the pattern counter of “PU-A→PU-B→PU-A” of the PI counter 321 exceeds the prediction mode on threshold.

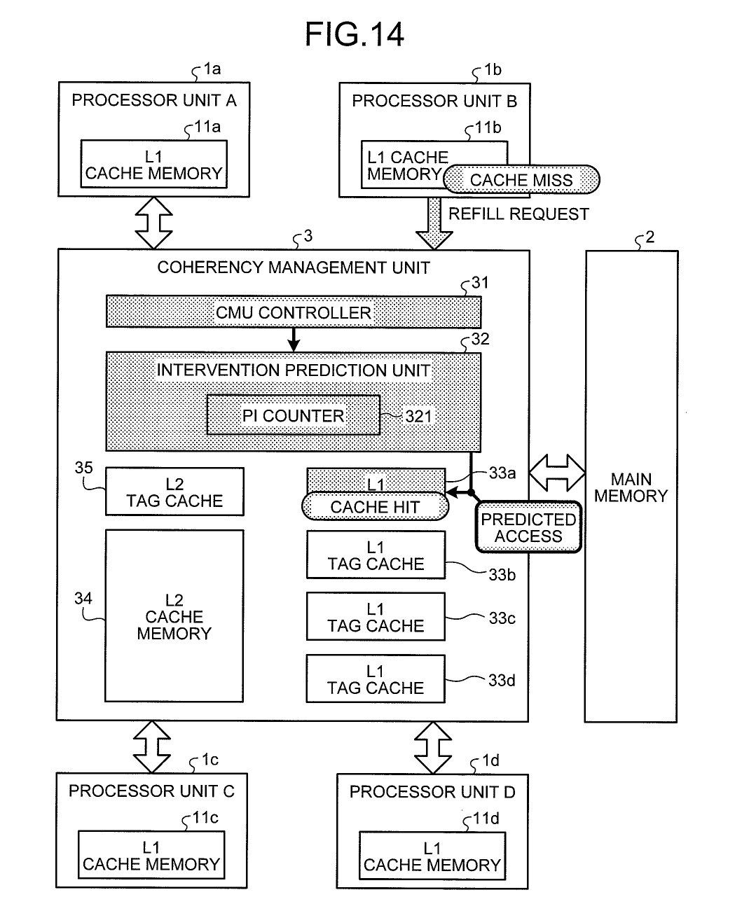

FIG. 14 is a diagram of operation performed after a counter value exceeds a threshold because of intervention transfer performed in the past and the PIU 32 switches to the predicting intervention mode (in other words, operation performed when the predicting intervention mode is valid). At this point, the PIU 32 is in the predicting intervention mode and predicts that a cache line requested by the L1 cache memory 11b is present in the L1 cache memory 11a. It is necessary to read out all the tag caches in a state without a prediction. However, a reduction in power consumption is attained by reading out only the L1 tag cache 33a related to the L1 cache memory 11a according to the prediction of the PIU 32.

In a processing flow shown in FIG. 10, a prediction is correct at a high probability and a hit is obtained from the L1 tag cache 33a. After the hit is confirmed by the CMU controller 31, intervention transfer of the cache line is performed from the L1 cache memory 11a and the L1 cache memory 11b. When counter values of the pattern counters exceed the prediction mode on threshold, it is possible to select, according to operation same as the operation in the first embodiment, a predicting intervention mode concerning which pattern should be adopted.

Depending on an intervention transfer pattern, it is also conceivable that a plurality of cache memories as candidates of a transfer source of intervention transfer are present. As a specific example, in the case of the transfer pattern “PU-A→PU-B→PU-D→PU-B→PU-A”, both first intervention transfer PU-A→PU-B of the pattern and third intervention transfer PU-D→PU-B are intervention transfer with the L1 cache memory 11b set as a transfer destination. Therefore, when a refill request is received from the processor unit 1b, the CMU controller 31 needs to distinguish whether the refill request is a refill request corresponding to the first intervention transfer of the pattern or a refill request corresponding to the third intervention transfer. In other words, when the refill request is received from the processor unit 1b, the CMU controller 31 needs to determine whether a transfer source of intervention transfer should be predicted as the L1 cache memory 11b or should be predicted as the L1 cache memory 11d.

As an example of a method of specifying the transfer source of the intervention transfer, the CMU controller 31 can store, in a period from a point when a refill request corresponding to the first intervention transfer of the pattern is received until the end of the pattern, how many times the intervention transfer is performed for an address designated by the refill request. In the transfer pattern explained as the specific example, it is possible to specify a cache memory as a transfer source by determining whether the intervention transfer is the first intervention transfer or the third intervention transfer in the pattern.

The CMU controller 31 can store, in a period from a point when a refill request corresponding to the first intervention transfer of the pattern is received until the end of the pattern, the number of refill requests from the respective cache memories for an address designated by the refill request. In the transfer pattern explained as the specific example, it is possible to specify a cache memory as a transfer source by determining whether the refill request is a first refill request or a second refill request by the processor unit 1b for a certain address.

The CMU controller 31 can activate tags corresponding to a plurality of cache memories as candidates of the transfer source. In the transfer pattern explained as the specific example, when the refill request from the processor unit 1b is received, the CMU controller 31 can activate and read out the L1 tag caches 33a and 33d. In this case, when the CMU 3 receives the refill request from the processor unit 1b, the CMU controller 31 does not need to determine whether the refill request is a refill request for the first intervention transfer of the pattern or a refill request for the third intervention pattern transfer of the pattern.

In this embodiment, ON and OFF of the predicting intervention mode is switched based on the number of times of coincidence with a predetermined intervention transfer pattern rather than the number of times of intervention transfer in a specific processor pair. Therefore, a prediction is performed under a more strict condition compared with the first embodiment. Therefore, because accuracy of prediction of intervention transfer is improved, it is possible to prevent power consumption and processing time from increases because of a wrong prediction.

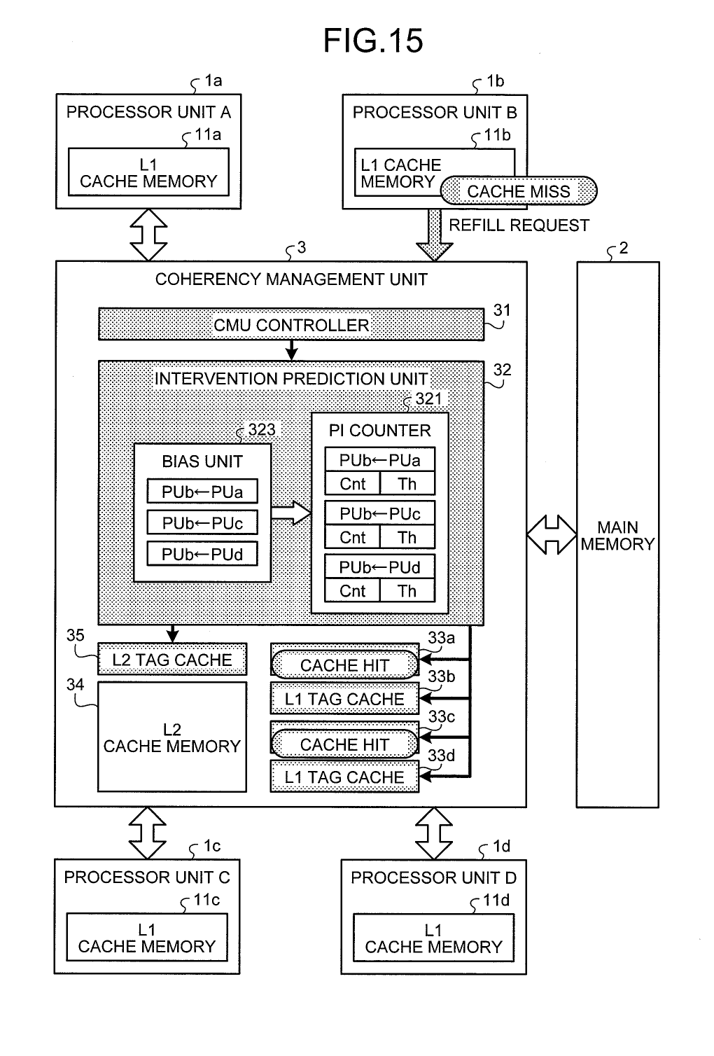

FIG. 15 is a diagram of the configuration of a multiprocessor according to a third embodiment of the present invention. In the first and second embodiments, a prediction of intervention transfer is performed based on a flow of a cache line or data in the multiprocessor. However, in this embodiment, intervention transfer is predicted with hardware configuration and power consumption in the multiprocessor taken into account.

The configuration of the multiprocessor is substantially the same as that in the first embodiment but is different in that the PIU 32 as a predicting unit further includes a bias unit 323. The PI counter 321 is the same as that in the first embodiment and includes counters corresponding to processor pairs.

The bias unit 323 acts to apply fixed bias to logic for determining whether the counters corresponding to the processor pairs of the PI counter 321 exceed the prediction mode on threshold.

For example, intervention transfer was performed five times from the processor unit 1a to the processor unit 1b in the past and stored as a counter value of “PUb←PUa”. On the other hand, intervention transfer was performed six times from the processor unit 1c to the processor unit 1b in the past and stored as a counter value of “PUb←PUc”. It is assumed that prediction on mode thresholds (Th) of both the counter values are eight. The bias unit 323 applies two-times bias to “PUb←PUa” and applies one-time bias (substantially no bias) to “PUb←PUc”. In this case, the number of times of the intervention transfer from the processor unit 1a to the processor unit 1b in the past is small compared with that of the processor unit 1c. However, because a counter value of the counter of PUb←PUa exceeds the prediction mode on threshold (five times×2=ten times>threshold (eight times), the processor unit 1a is predicted as a transfer source in intervention transfer prediction with the processor unit 1b set as a transfer destination.

In a state without bias to “PUb←PUa” and “PUb←PUc”, the counter values do not exceed the threshold. Therefore, when a refill request due to a cache miss is received from the processor unit 1b, the CMU controller 31 reads all the tag caches (the L1 tag caches 33a to 33d and the L2 cache 35) and obtains cache hits in the L1 tag cache 33a and the L1 tag cache 33c (a state in which the same cache line is already shared by the L1 cache memory 11a and the L1 cache memory 11c). It depends on a packaging state of the processor unit 1 whether intervention transfer is performed from the L1 cache memory 11a or the L1 cache memory 11c.

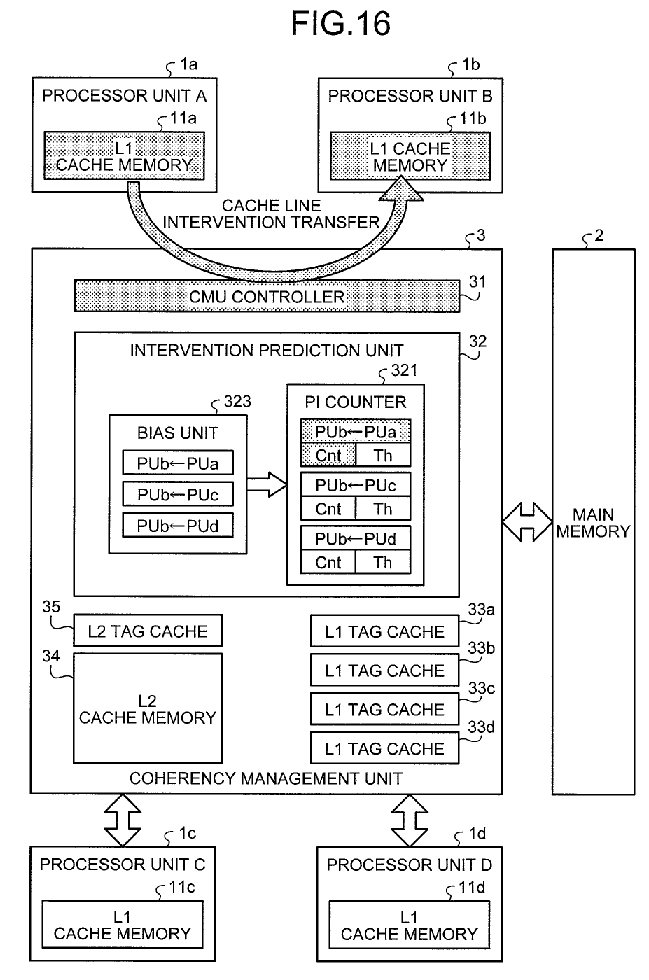

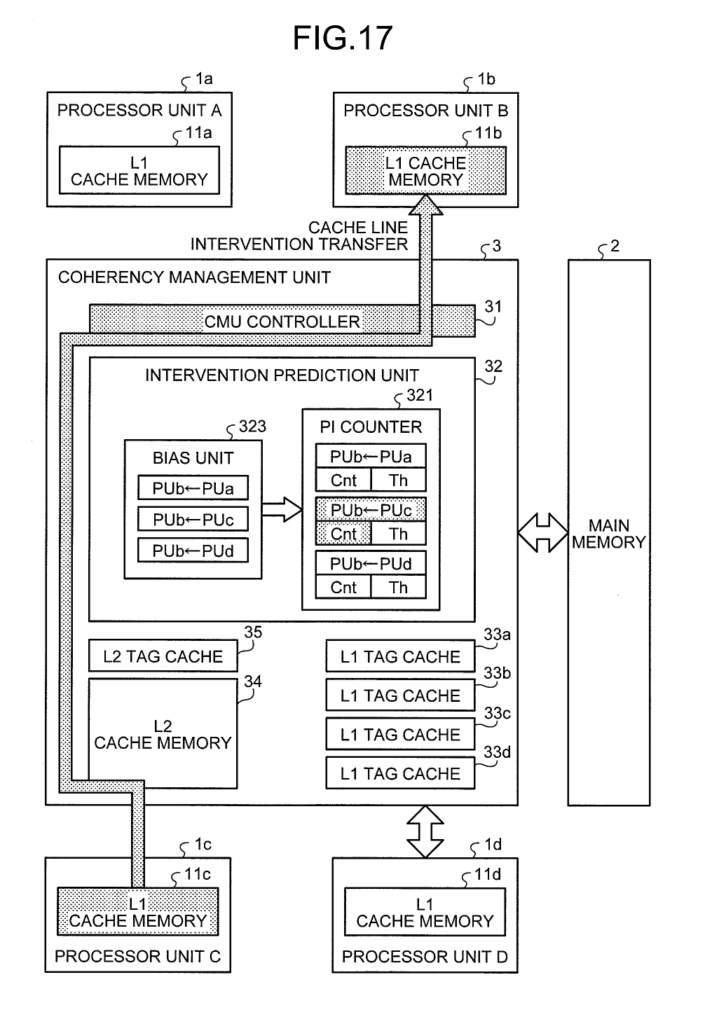

When the L1 cache memory 11a is selected, as shown in FIG. 16, the intervention transfer is performed from the L1 cache memory 11a to the L1 cache memory 11b. A counter of a corresponding processor pair of the PI counter 321 in the PIU 32 is incremented. On the other hand, when the L1 cache memory 11c is selected, as shown in FIG. 17, the intervention transfer is performed from the L1 cache memory 11c to the L1 cache memory 11b. A counter of a corresponding processor pair of the PI counter 321 in the PIU 32 is incremented. In this case, a cache line of the L1 cache memory 11a and a cache line of the L1 cache memory 11c are the same. Therefore, cache line arriving at the L1 cache memory 11b is the same and coherency of a cache is maintained. However, power consumption involved in the intervention transfer is larger when the transfer from the L1 cache memory 11c to the L1 cache memory 11b is performed (this is because a distance between processors on a system is larger and the number of pieces of not-shown hardware require to be driven during transfer increases). Therefore, the bias unit 323 applies fixed bias to the L1 cache memory 11a side. This makes it easy for the PIU 32 to switch to the predicting intervention mode from the L1 cache memory 11a and makes it possible to facilitate the intervention transfer from the L1 cache memory 11a with less power consumption to the L1 cache memory 11b.

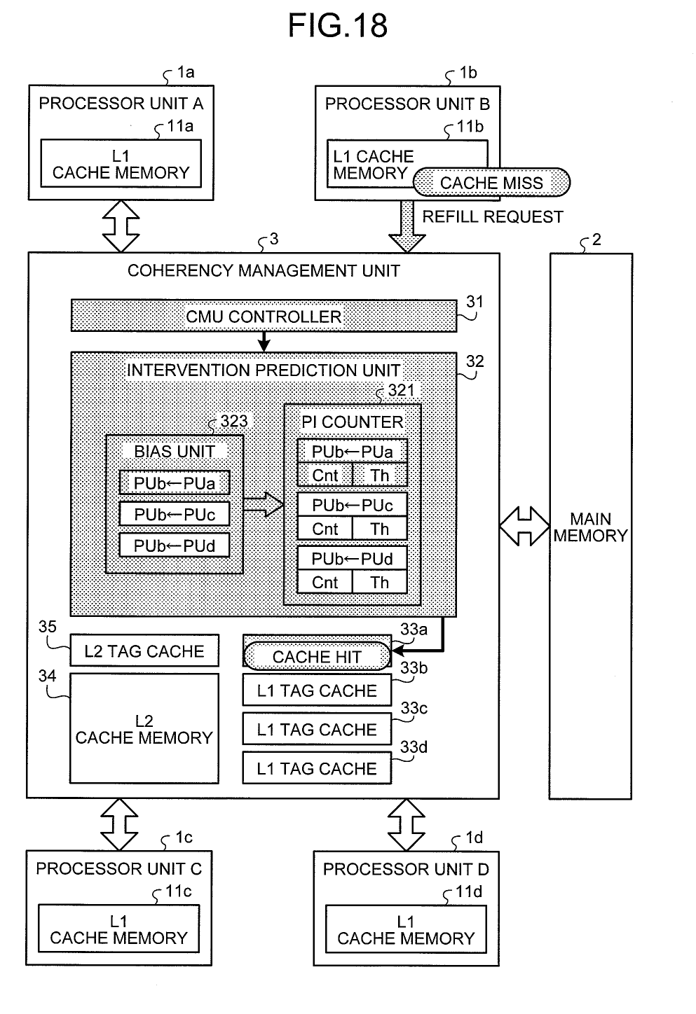

FIG. 18 is a diagram of a state in which the predicting intervention mode concerning the L1 cache memory 11a is validated by the bias unit 323. In the state in which the predicting intervention mode is validated, it is possible to obtain a hit by referring only the L1 tag cache 33a according to the PIU 32 and perform transfer from the L1 cache memory 11a with less power consumption involved in intervention transfer to the L1 cache memory 11b.

In this way, it is possible to reduce power consumption of the entire multiprocessor by giving, with the bias unit 323, fixed priority to switching to the prediction mode of the intervention transfer with less power consumption. Even when the bias unit 323 is not provided, it is possible to increase priority of switching to the intervention transfer with less power consumption by setting the prediction mode on priority of the PI counter 321 in the PIU 32 low between processor units with less power consumption involved in transfer.

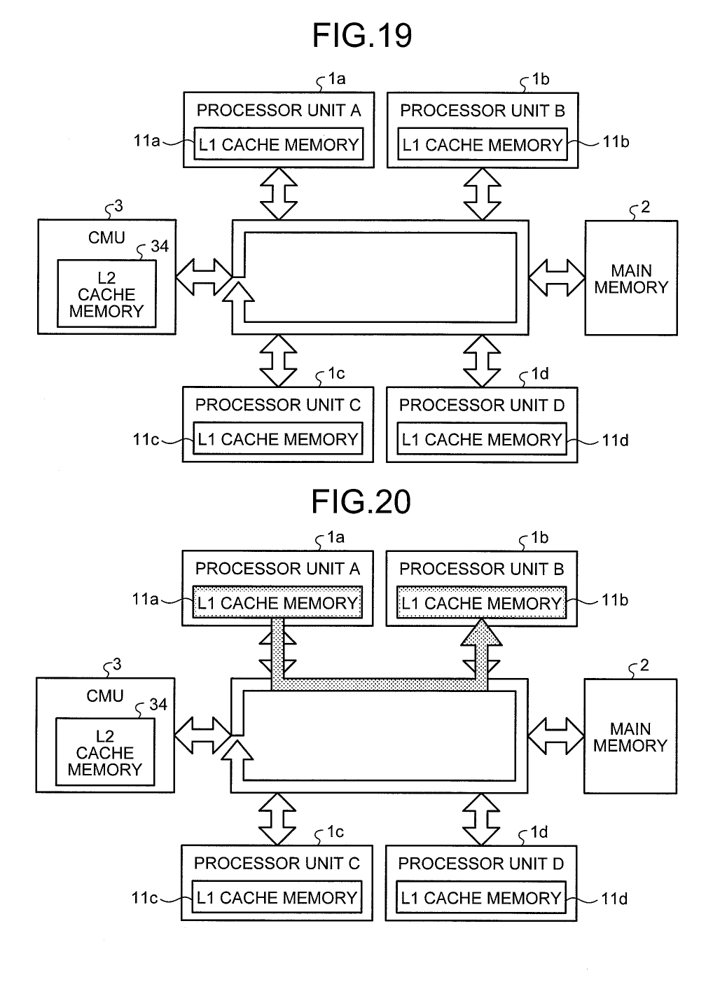

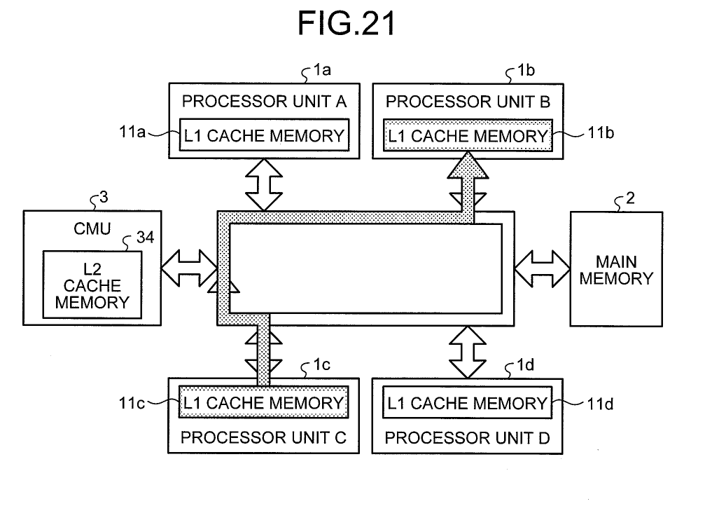

In the above explanation, the multiprocessor in which the processor units 1 are connected via the CMU 3 is explained as an example. However, a connection form of the processor units 1 is arbitrary. As a form of another connection method, a configuration in which the processor units 1, the CMU 3, and the main memory 2 are connected by a ring bus is shown in FIG. 19. States of intervention transfer in a multiprocessor of a ring bus form are shown in FIGS. 20 and 21. As shown in the figures, it is seen that a distance on the ring bus is large and, at the same time, power consumption is high in the intervention transfer from the processor unit 1c to the processor unit 1b compared with the intervention transfer from the processor unit 1a to the processor unit 1b. Even in such a multiprocessor of the ring bus form, it is possible to give priority to the intervention transfer with less power consumption by, for example, providing the bias unit 323 and separately setting prediction mode on thresholds.

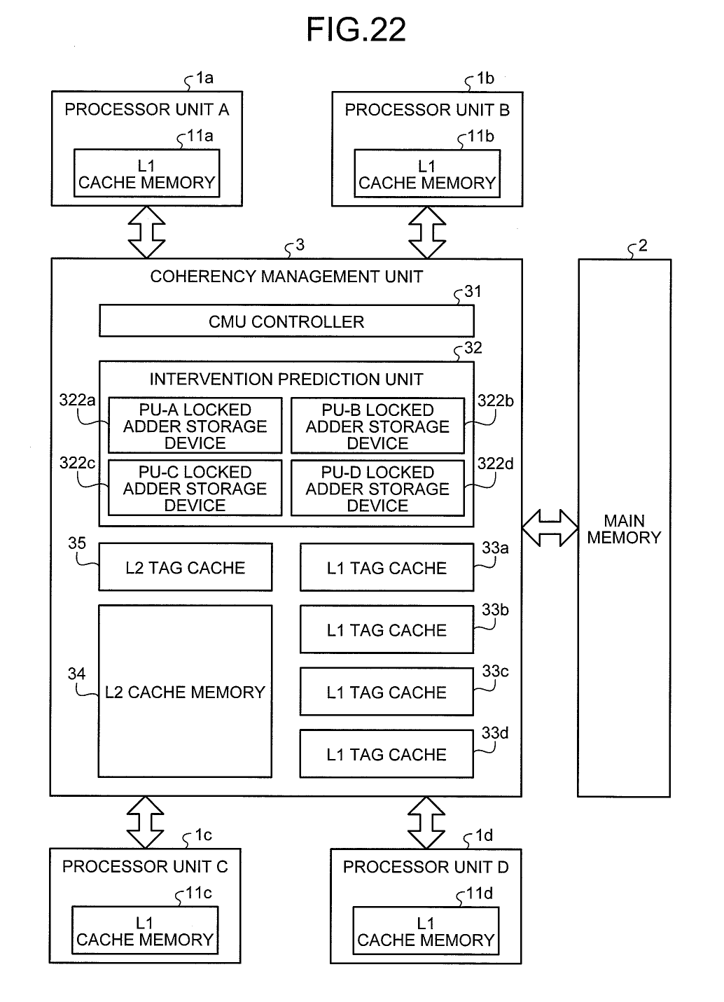

FIG. 22 is a diagram of the configuration of a multiprocessor according to a fourth embodiment of the present invention. The configuration is different from the configuration of the multiprocessors according to the first to third embodiments in that the PIU 32 includes locked adder storage devices 322 (322a to 322d) instead of the PI counter 321. The locked adder storage devices 322a to 322d store addresses attempted to be locked by 11 commands from the processor units. The number of addresses stored by the locked adder storage devices 322a to 322d corresponding to the respective processor units is arbitrary and is not limited to one (in packaging, the number of stored addresses depends on tradeoff with hardware cost).

When a plurality of processor units share a memory space and perform program processing, in some cases, “exclusive processing execution” for not allowing intervention of other processor units is necessary in a fixed processing section. In this case, a processor unit performs exclusive control after acquiring a lock variable (1: lock, 0: unlock) for treating a fixed memory area by performing a sequence explained below and releases the memory area together with the lock variable after the processing.

### An Execution Flow of the Exclusive Control

### [Retry]

### ld R0, RA

bnez R0 [Retry]
movi R0, 1

### ll R1,RA

### sc R0 RA

beqz R0 [Retry]

### Exclusive Processing

movi R0, 0

### suc R0, RA

The execution commands in the flow are explained. “ld (Load)” is a command for reading a value from a memory area. In the flow, a value of a lock variable in the present state is read in a register R0 from a memory address RA that stores the lock variable. “bnez (Branch Not Equal Zero)” is a command for dividing, when a value of a register does not coincide with 0, the processing to a label at a designated destination. In the flow, when a read-out lock variable is not 0 (unlock), the processor unit returns to the [Retry] label and performs the flow again. “movi (Move Immediately)” is a command for storing an immediate value in a designated address. In the flow, a value 1 is stored in the register R0. “ll (Load Locked)” is a command for reading a value from a designated memory address and at the same time registering a lock indicator (and an address) indicating that “the processor is accessing to lock this area”. In the flow, a value is read out from a memory address designated by a register RA to a register R1 and the indicator (and the address) is registered. “sc (Store Conditional)” following ll is a command for writing a value in a designated memory area on condition that “other processors do not access the same area after the lock indicator is registered”. In the flow, storage of R0 (a value is 1) in the memory address designated by the register RA is attempted and a result is stored in the register R0 as success (1) or failure (0). “beqz (Branch Equal Zero)” is a command for dividing, when a value of a register coincides with 0, the processing to a label at a designated designation. In the flow, when a result of success or failure of the sc command is 0 (failure), the processor unit returns to the [Retry] label and performs the flow again.

At a point when the processing ends, the processor unit that performs the flow has exclusively acquired a lock variable and a memory area corresponding thereto. Therefore, the processor unit performs a series of exclusive processing. After performing the exclusive processing, the processor unit unconditionally writes a value 0 according to “suc (Store Unconditional)” to release the lock variable, resets the lock variable to unlock (the value 0), and releases the area.

The flow is a publicly-known flow as explained in John L Hennessy & David A Patterson “COMPUTER ARCHITECTURE A QUANTITATIVE APPROACH 2nd Edition”.

A predicting intervention system linked to the flow of the exclusive processing is explained below. Execution of a computer program involving exclusive control is further classified into the following three systems:

(1) a predicting intervention system associated with “sc”;
(2) a predicting intervention system associated with “ll”; and
(3) a predicting intervention system associated with “ld”.

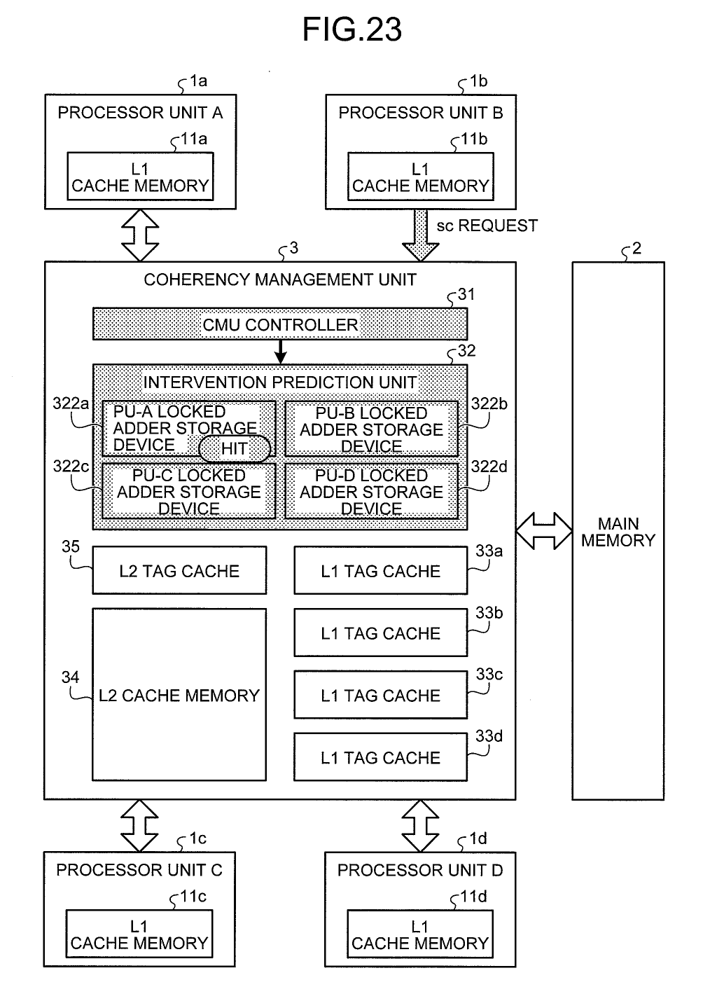

The predicting intervention system associated with “sc” of (1) is explained below. The processor unit 1a secures a memory area and performs the exclusive processing according to the flow and releases the memory area. Thereafter, the processor unit 1b executes the flow on the same memory area and writes the lock variable in the memory area according to “sc”. A state in this case is shown in FIG. 23.

In FIG. 23, the processor unit 1b executes the sc command and checks the locked adder storage devices 322a to 322d in the PIU 32. The processor unit 1b checks a lock indicator (and an address) of a processor unit 1b and confirms that, after the processor unit 1b issues the ll command, the other processor units simultaneously secure a lock variable arranged in the same address. At the same time, the processor unit 1b determines whether an address of a lock variable currently secured by the other processor units or a lock variable secured in the past by the other processor units coincide with an address of a lock variable currently secured by the processor unit 1b. In this case, a lock variable secured by the processor unit 1a is secured for the use by the processor unit 1b after the use in the processor unit 1a. For this purpose, as shown in FIG. 23, an address stored in the PU-A locked adder storage device 322a coincide with an address of a lock variable that the processor unit 1b is about to secure according to sc (hit).

At this point, the PIU 32 can detect that “the processor unit 1b inherits and uses a memory area exclusively used by the processor unit 1a”. Therefore, the PIU 32 predicts that a cache line to be required because of a cache miss from the processor unit 1b (the L1 cache memory 11b) is present in the L1 cache memory 11a in the processor unit 1a, which uses the same area, and turns on the predicting intervention mode.

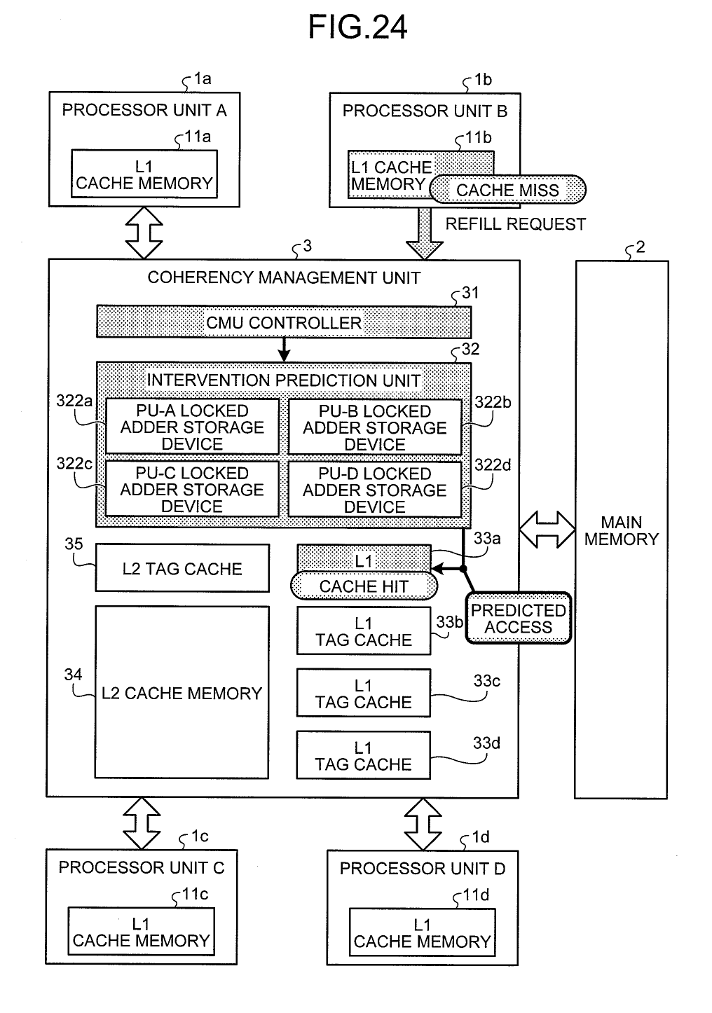

A state in which a cache miss occurs in the L1 cache memory 11b after the intervention prevention mode is turned on is shown in FIG. 24. In the state in which the predicting intervention mode is turned on, the PIU 32 predicts that a cache line required by the L1 cache memory 11b is present in the L1 cache memory 11a, accesses only the L1 tag cache 33a concerning the L1 cache memory 1a in the CMU 3, and obtains a cache hit. In this way, it is possible to predict intervention transfer between processors according to a command and coincidence of an address used for the exclusive control.

The predicting intervention system associated with “ll” of (2) is explained below. In the predicting intervention system associated with “sc” of (1), the comparison of an address for securing a lock variable is performed in association with the sc command of the exclusive control flow. However, in the predicting intervention system associated with “ll”, at a stage when an access to a lock variable is tried according to the ll command in the former half of the flow, comparison with an address of a lock variable secured by the other processor units is performed. This is a system for effectively performing prediction of intervention transfer not only for a processor unit that finally secures a lock variable according to sc but also for a processor unit that tries to secure a lock variable according to the ll command but cannot secure a lock variable at a stage of the sc command.

The predicting intervention system associated with “ld” of (3) is explained. In this system, comparison with an address of a lock variable secured by the other processing units is performed at a stage when an access to a lock variable is performed to check a value of the lock variable according to the ld command at the beginning of the flow. This is a system for applying prediction of intervention transfer to a processor unit that has not tried to secure a lock variable but will try in future. A system is not limited to this system associated with the ld. A system for reflecting, at a stage when some memory access is simply performed to an address of a lock variable secured by the other processor units, the address on the predicting intervention (relaxing limitation) is also conceivable.

The releasing system linked to the area release of the exclusive control flow is explained. As explained above, the switching to the predicting intervention mode can be linked to commands at a plurality of stages (in forms linked to ld, ll, and sc) for shift to the exclusive processing in the exclusive control execution flow. However, the release of the predicting intervention mode is linked to the “suc” command for releasing a lock variable after the “exclusive processing”. Specifically, in a period in which a certain processor inherits a lock variable and a memory area used by the other processor units and performs the exclusive processing, the predicting intervention mode is kept valid. Then, the predicting intervention mode is invalidated simultaneously with a procedure for releasing thee area (release of the lock variable according to the suc command).

As explained above, in this embodiment, ON and OFF of the predicting intervention mode are switched while being linked to the commands of the exclusive control flow. Only a tag memory concerning a cache memory in which a cache line as a transfer target is predicted to be present is started to check presence or absence of the cache line. Therefore, it is possible to lower an HW driving ratio during intervention transfer between a specific processor (L1 cache memory) pair and reduce power consumption of the multiprocessor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A multiprocessor comprising:
a main storage device;
a plurality of processors configured to share the main storage device, each processor comprising one or more cache memories configured to temporarily store data from the main storage device; and
a coherency manager configured to manage coherency between the cache memories of the processors;
wherein the coherency manager comprises:
a plurality of tag caches corresponding to respective cache memories and configured to store tags of cache data cached in the cache memories;
a data manager configured to identify, according to a refill request from the processors, a cache memory in which cache data corresponding to the refill request is cached by referring to the tag caches and further configured to transfer the cache data corresponding to the refill request from a transfer source to a transfer destination, wherein the identified cache memory is the transfer source and the cache memory at a refill request source is the transfer destination; and
a provisioner configured to monitor transfers of cache data and to determine a provisional transfer source for a transfer destination by predicting the transfer source based on the monitored transfers; and
wherein the data manager is further configured to activate, after the provisioner determines a provisional transfer source, a tag cache corresponding to the provisional transfer source when cache data is transferred and further configured to determine whether the cache data corresponding to the refill request is cached by referring to the activated tag cache.

2. The multiprocessor according to claim 1, wherein the provisioner identifies, for a transfer destination, a cache memory having a transfer count that has reached a transfer threshold earliest, and determines the identified cache memory as the provisional transfer source for the transfer destination.

3. The multiprocessor according to claim 2, wherein the provisioner is configured to determine a provisional transfer source based on priorities set for each cache memory when a prediction failure count reaches a prediction failure threshold.

4. The multiprocessor according to claim 2, wherein the provisioner is configured to identify a cache memory, other than the provisional transfer source, having a transfer count that has reached a transfer threshold earliest, when a prediction failure count reaches a prediction failure threshold and a previous provisional determination is canceled, and further configured to determine the identified cache memory as the provisional transfer source.

5. The multiprocessor according to claim 2, wherein the provisioner is configured to determine, as the provisional transfer source, a cache memory having a transfer count that has reached a transfer threshold most often, when a prediction failure count reaches a prediction failure threshold.

6. The multiprocessor according to claim 2, wherein the provisioner is configured to determine, as the provisional transfer source, a cache memory that has been most recently used when a prediction failure count reaches a prediction failure threshold.

7. The multiprocessor according to claim 2, wherein the provisioner is configured to hold a prediction failure count for a cache memory constant while the cache memory is determined to be the provisional transfer source and until the cache memory is canceled as the provisional transfer source.

8. The multiprocessor according to claim 1, wherein the provisioner is configured to identify, among a plurality of transfer patterns having accessed a cache line two or more times in a row, a transfer pattern having an execution count that reaches an execution threshold earliest, and further configured to determine the provisional transfer source according to a relationship between transfer sources and transfer destinations represented by the identified transfer pattern.

9. The multiprocessor according to claim 1, wherein the provisioner is configured to cancel the determination of the provisional transfer source when when a prediction failure count reaches a prediction failure threshold.

10. The multiprocessor according to claim 9, wherein the provisioner is configured to periodically update the prediction failure count.

11. The multiprocessor according to claim 1, wherein the data manager is configured to preferentially select a cache memory having a short data transfer path in transfer of cache data when a plurality of cache memories, in which cache data corresponding to the refill request is cached, are identified.

12. The multiprocessor according to claim 1, wherein the provisioner is configured to determine, as the provisional transfer source, a cache memory included in a processor at an inheritance source of a memory space when:
the processors have the memory space on the main storage device;
the processors perform program processing; and
the processors inherit a memory space managed by a processor under exclusive control.

13. The multiprocessor according to claim 12, wherein the provisioner is configured to cancel the determination of the provisional transfer source when the processor that inherited the memory space releases the memory space.

14. The multiprocessor according to claim 1, further comprising:
a shared cache memory shared among the processors;
wherein the provisioner is further configured to include the shared cache memory in determining the provisional transfer source.

15. A multiprocessor comprising:
a main storage device;
a plurality of processors, each processor comprising:
a cache memory configured to temporarily store data from the main storage device;
a tag cache configured to store tags of cache data cached in the cache memory;
a data manager configured to identify, according to a refill request from the processors, a cache memory in which cache data corresponding to the refill request is cached by referring to the tag caches and further configured to transfer the cache data corresponding to the refill request from a transfer source to a transfer destination, wherein the identified cache memory is the transfer source and the cache memory at a refill request source is the transfer destination; and
a provisioner configured to monitor transfers of cache data and to determine a provisional transfer source for a transfer destination by predicting the transfer source based on the monitored transfers; and
a coherency manager configured to manage coherency between the cache memories of the processors;
wherein the data manager is further configured to activate, after the provisioner determines a provisional transfer source, a tag cache corresponding to the provisional transfer source when cache data is transferred and further configured to determine whether the cache data corresponding to the refill request is cached by referring to the activated tag cache.

16. The multiprocessor according to claim 15, wherein the provisioner identifies, for a transfer destination, a cache memory having a transfer count that has reached a transfer threshold earliest, and determines the identified cache memory as the provisional transfer source for the transfer destination.

17. The multiprocessor according to claim 15, wherein the provisioner is configured to identify, among a plurality of transfer patterns having accessed a cache line two or more times in a row, a transfer pattern having an execution count that reaches an execution threshold earliest, and further configured to determines the provisional transfer source according to a relationship between transfer sources and transfer destinations represented by the identified transfer pattern.

18. The multiprocessor according to claim 15, wherein the provisioner is configured to cancel the determination of the provisional transfer source when when a prediction failure count reaches a prediction failure threshold.

19. The multiprocessor according to claim 15, wherein the data manager is configured to preferentially select a cache memory having a short data transfer path in transfer of cache data when a plurality of cache memories, in which cache data corresponding to the refill request is cached, are identified.

20. The multiprocessor according to claim 15, wherein the provisioner is configured to determine, as the provisional transfer source, a cache memory included in a processor at an inheritance source of a memory space when:
the processors have the memory space on the main storage device;
the processors perform program processing; and
the processors inherit a memory space managed by a processor under exclusive control.
